(19) United States
(12) Patent Application Publication
(10) Pub. No.: US 2013/0174199 A1
(43) Pub. Date: Jul. 4, 2013

(54) METHODS, SYSTEMS, AND MEANS FOR PRESENTING MENU OPTIONS IN A MEDIA GUIDANCE APPLICATION

(71) Applicants: Christopher Dow, San Francisco, CA (US); Geoff Ehlers, Santa Rosa, CA (US)

(72) Inventors: Christopher Dow, San Francisco, CA (US); Geoff Ehlers, Santa Rosa, CA (US)

(73) Assignee: UNITED VIDEO PROPERTIES, INC., Santa Clara, CA (US)

(21) Appl. No.: 13/339,894

(22) Filed: Dec. 29, 2011

(51) Int. Cl. H04N 21/482

(52) U.S. Cl. 725/40

(57) ABSTRACT

Methods, systems, and means for presenting menu options in a media guidance application are provided. In particular, a user selection of a primary menu option is received in the media guidance application. A plurality of sub-menu options that correspond to the primary option selected is determined. Subsequently, for each of the plurality of sub-menu options, it is determined whether the sub-menu option has guidance data and/or content associated with the primary menu option selected. This guidance data and/or content can be either data and/or media in accordance with some embodiments of the invention. For each of the plurality of sub-menu options that does not have guidance data and/or content associated with the primary menu option selected, the sub-menu option is prevented from being presented to a user.

### BACKGROUND OF THE INVENTION

Due to the large quantity of media available to users in any given media delivery system, interactive media guidance applications have been developed in order to allow users to more efficiently navigate media selections and more easily identify media that they may desire.

A variety of menus within a media guidance application may be available to users which can assist in navigating among and locating desirable guidance data and/or content. However, the presence of a menu option may suggest to a user that guidance data and/or content that corresponds to the option is available, when, in fact, no such guidance data and/or content is available. This can make navigating and locating desired guidance data and/or content more difficult and frustrating.

### SUMMARY OF THE INVENTION

In view of the foregoing, methods, systems, and means for presenting menu options in a media guidance application are provided. In some embodiments, a user selection of a primary menu option is received in the media guidance application. A plurality of sub-menu options that correspond to the primary option selected is determined. Subsequently, for each of the plurality of sub-menu options, it is determined whether the sub-menu option has guidance data and/or content associated with the primary menu option selected. This guidance data and/or content can be either data and/or media in accordance with some embodiments of the invention. For each of the plurality of sub-menu options that does not have guidance data and/or content associated with the primary menu option selected, the sub-menu option is prevented from being presented to a user.

In some embodiments, the primary menu option selected is a program listing option. In particular, in some embodiments, when a program listing option is selected, the corresponding sub-menu option prevented from being presented to the user is one of: a history option; a similar option; a watch option; an overview option; a summary option; a review option; a cast option; a photos option; and an awards option.

In some embodiments, the primary menu option selected is a category of program, wherein the category of program is one of comedy, action, drama, sports, movies, kids, and news. In particular, in some embodiments, when a category of program is selected, the corresponding sub-menu option prevented from being presented to the user is one of: an on-demand listing option; a broadcast listings option; a pay-per-view listings option; and an archive listings option.

In some embodiments, the primary menu option selected is a social media option. In particular, in some embodiments, when a social media option is selected, the corresponding sub-menu option prevented from being presented to the user is one of: a blogging option; a micro-blogging option; a social networking option; a content community option; a collaborative project option; a virtual environment option.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1-5 show various illustrative display screens that may be used to provide media guidance in accordance with some embodiments of the invention.

FIG. 6 is a diagram of a process for determining if a sub-menu option has guidance data and/or content associated in some embodiments of the invention.

FIGS. 7-9 show various illustrative display screens that may be used to provide media guidance in accordance with some embodiments of the invention.

FIG. 10 is a diagram of a process for determining if a sub-sub-menu option has guidance data and/or content associated in some embodiments of the invention.

FIGS. 11 and 12 show examples of XML structures for menu options in accordance with some embodiments of the invention.

FIGS. 13 and 14 show generalized embodiments of illustrative user equipment devices, on which a media guidance application may be implemented in accordance with some embodiments of the invention.

### DETAILED DESCRIPTION OF EMBODIMENTS

The invention generally relates to methods, systems, and means for presenting menu options in a media guidance application. In particular, a user selection of a primary menu option is received in the media guidance application. A plurality of sub-menu options that correspond to the primary option selected is determined. Subsequently, for each of the plurality of sub-menu options, it is determined whether the sub-menu option has guidance data and/or content associated with the primary menu option selected. This guidance data and/or content can be either data and/or media in accordance with some embodiments of the invention. For each of the plurality of sub-menu options that does not have guidance data and/or content associated with the primary menu option selected, the sub-menu option is prevented from being presented to a user.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. The various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

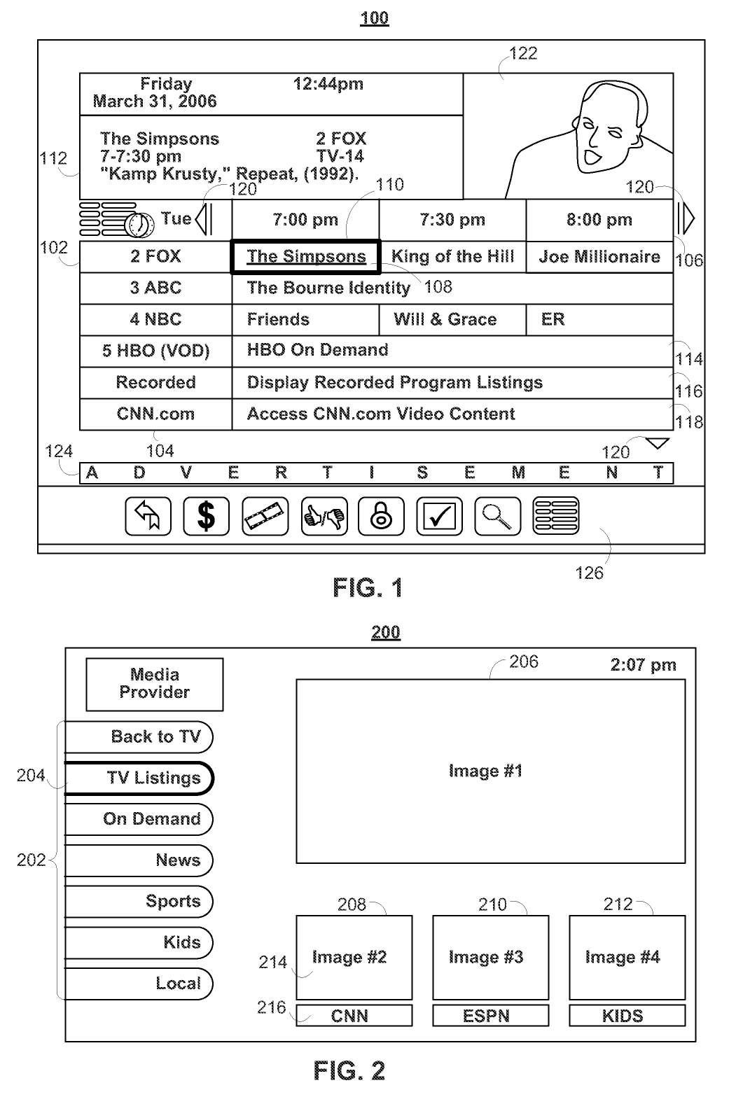

FIGS. 1-2 show illustrative display screens that may be used to provide media guidance data. The display screens shown in FIGS. 1-2, 3-5, and 7-9 may be implemented on any suitable user equipment device or platform. While the displays of FIGS. 1-2, 3-5, and 7-9 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 14. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

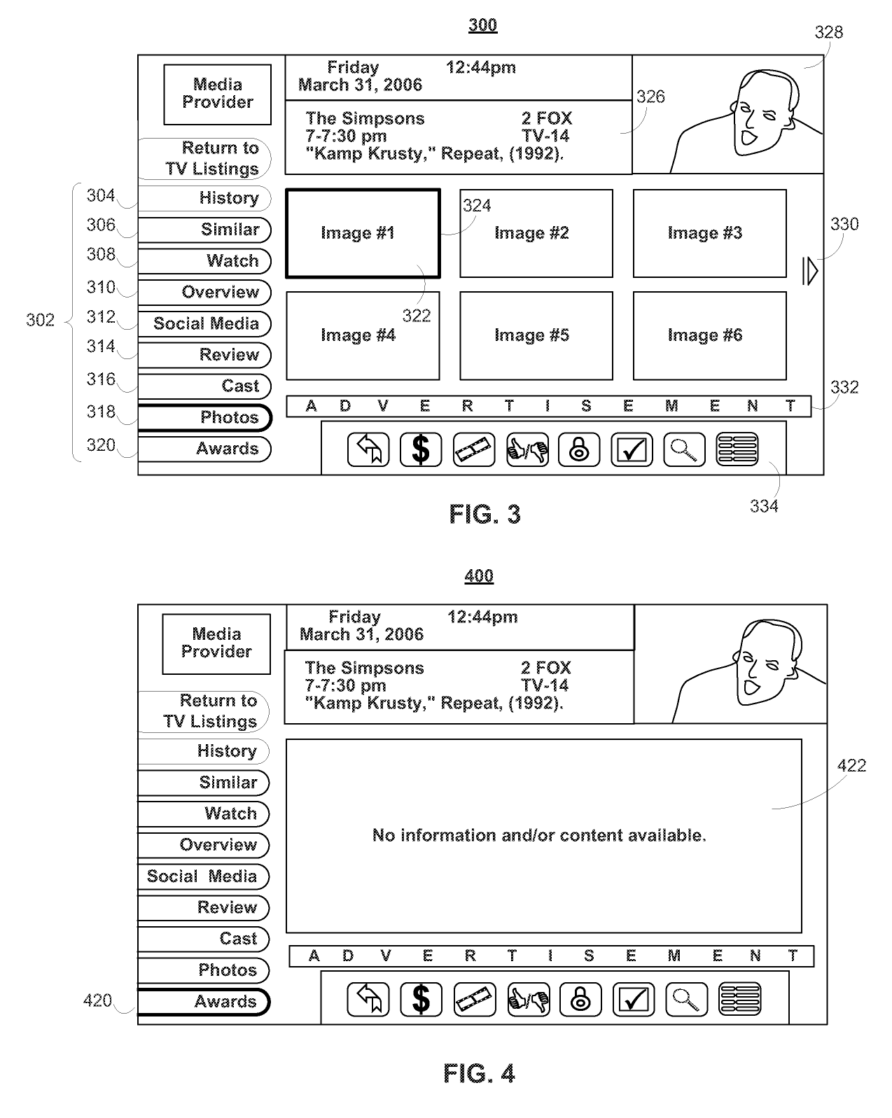

Yet another display arrangement for providing media guidance is shown in display 300 of FIG. 3. As illustrated, display 300 may be used to present guidance data and/or content corresponding to a selected primary menu option—for example, program listing 108 of FIG. 1.

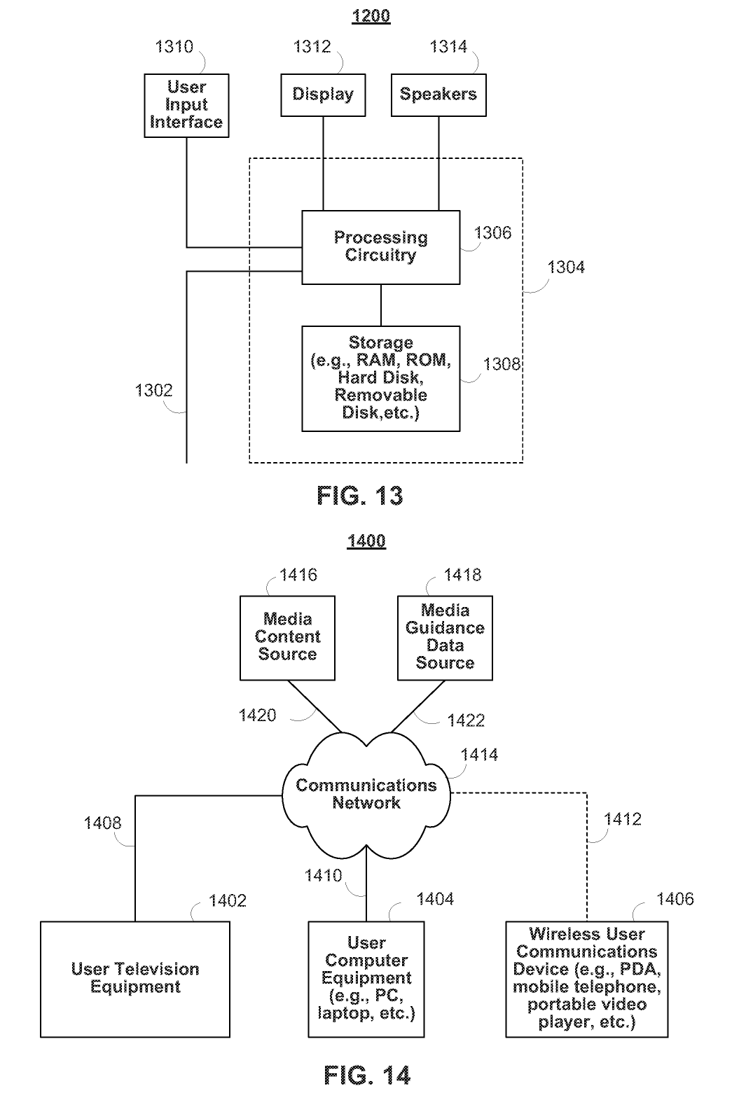

Display 300 may be presented by control circuitry 1304 in response to the control circuitry receiving an indication that a user has selected program listing 108 of FIG. 1, for example. Any suitable mechanism for receiving an indication that a user has selected a program listing (such as program listing 108) can be used in some embodiments. For example, control circuitry 1304 may receive an indication as a signal from user input interface 1310 (FIG. 13) indicating that a menu button has been pressed when highlight region 110 (FIG. 1) is on program listing 108.

Any suitable guidance data and/or content may be presented in display 300 in some embodiments. For example, in some embodiments, control circuitry 1304 may present guidance data relating to a program listing (such as program listing 108 of FIG. 1) in program information region 326 of display 300. This region may be similar to program information region 112 of FIG. 1 in that it may include, for example, the program title, the program description, the time the program is provided (if applicable), the channel the program is on (if applicable), the program's rating, and any other suitable information, as previously described.

As another example, in some embodiments, control circuitry 1304 may additionally or alternatively present a video region 328, an advertisement 332, and/or an options region 334. Video region 328, advertisement 332, and options region 334 may be similar to video region 122 of FIG. 1, advertisement 124 of FIG. 1, and options region 126 of FIG. 1, respectively, in some embodiments.

As still another example, in some embodiments, control circuitry 1304 may additionally or alternatively present sub-menu options 302 and then, in response to receiving a user selection of one of these sub-menu options, control circuitry 1304 may present guidance data and/or content based on the user selection of one of these sub-menu options.

Any suitable sub-menu options 302 may be used in some embodiments. For example, in connection with the selection of a program listing for a program as a primary menu option, sub-menu options 302 may include a “history” option 304 (e.g., for presenting a history of previous actions in the guide), a “similar” option 306 (e.g., for presenting information on similar programs to the program), a “watch” option 308 (e.g., for presenting a list of options to watch the program), an “overview” option 310 (e.g., for presenting an overview of the program), a “social media” option 312 (e.g., for access to social media related to the program), a “review” option 314 (e.g., for presenting reviews of the program), a “cast” option 316 (e.g., for presenting cast information for the program), a “photos” option 318 (e.g., for presenting photos related to the program), and an “awards” option 320 (e.g., for presenting award information for the program), and/or any other suitable option.

In response to control circuitry 1304 (FIG. 13) receiving a user selection of one of these sub-menu options (e.g., via the user using user input interface 1310 of FIG. 13), control circuitry may cause guidance data and/or content associated with the sub-menu option and the primary option (e.g., program listing 108) to be presented. For example, as illustrated in FIG. 3, in response to control circuitry 1304 receiving a user selection of photos sub-menu option 318 after having selected program listing 108, images such as image 322 associated with THE SIMPSONS may be presented by control circuitry 1304. THE SIMPSONS is a trademark and copyright owned by 20th Century Fox Film Corporation.

More particularly, for example, in response to receiving the user selection of photos sub-menu option 318, control circuitry may submit a query to a database to retrieve photos associated with program listing 108 (e.g., THE SIMPSONS as shown in FIG. 3). In response to this query, control circuitry 1304 may receive any suitable number of images (or even no images, as discussed further below), filter the received images on any suitable basis (e.g., such as based on user preferences and/or a user profile), arrange the images (e.g., equally space the images in two rows of three) in a region of display 300, and cause the display 300 to be presented with the images.

In this example, any suitable images can be presented in some embodiments. For example, images may be screenshots, headshots of actors or actresses performing in the program, and/or any other type of images that may be associated with the program.

In some embodiments, control circuitry 1304 may be configured to allow a user to select an image and/or to be presented with additional images. For example, control circuitry 1304 may enable a user to select image 322, or any other image, by moving highlight region 324 to the image of the user's choice in response to directional inputs of the user to user input interface 1310. As another example, control circuitry 1304 may present to a user additional images in response to receiving a user selection of navigation icon 330 (from user input interface 1310). This may be performed by the control circuitry submitting a query for additional images to a database, receiving images in response to the query, arranging the received images, and causing the images to be presented on a display.

As mentioned above, in some scenarios, a sub-menu option may have no guidance data or content associated with a primary option (e.g., a selected program listing). For example, as described above, after sending a query for images related to program listing 108, control circuitry 1304 may receive a message that no query results were found from the database. In some embodiments, control circuitry 1304 may respond to such a message by presenting a message that indicates that no guidance data and/or content is available.

As shown in display 400 of FIG. 4, for example, when control circuitry 1304 receives a selection of an awards sub-menu option 420, control circuitry 1304 may send a query to a database for awards information related to a selected primary option (e.g., THE SIMPSONS as illustrated in FIG. 4). When no guidance data and/or content is associated with this sub-menu option, control circuitry 1304 may receive a suitable message from the database and then present message 422 in display 400 indicating that no guidance data and/or content is available.

In some embodiments, control circuitry 1304 may prevent sub-menu options for which no guidance data and/or content is available from being presented to, and/or available for selection by, a user.

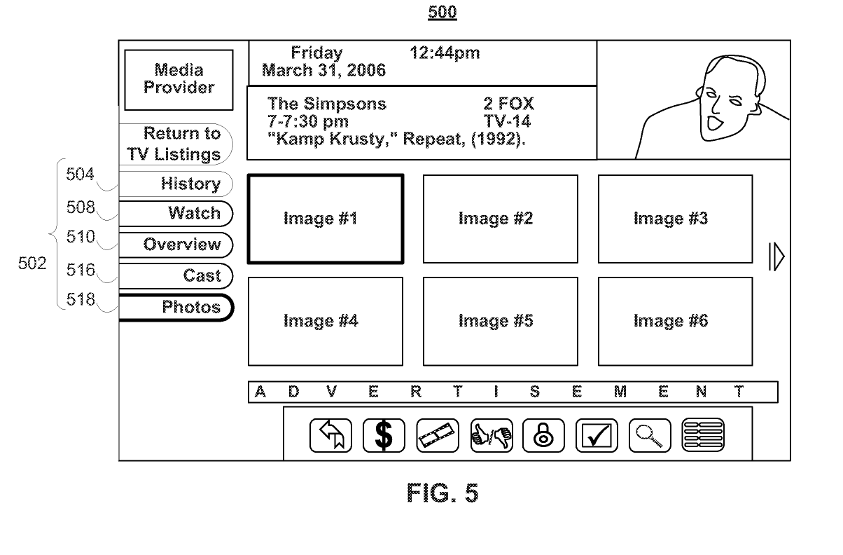

For example, in response to receipt of a selection of a primary option (e.g., program listing 108 of FIG. 1), control circuitry 1304 may determine that no guidance data and/or content is available for a “similar” option (e.g., shown as option 406 of FIG. 4), a “summary” option (e.g., shown as option 412 of FIG. 4), a “review” option (e.g., shown as option 414 of FIG. 4), and an “awards” option (e.g., shown as option 420 of FIG. 4). Accordingly, control circuitry 1304 may then prevent these sub-menu options from being presented or available to the user for selection as shown in display 500 of FIG. 5.

Likewise, control circuitry 1304 may determine that guidance data and/or content is available for certain sub-menu options for a selected primary option and accordingly cause those sub-menu options to be presented and/or available. For example, as illustrated, control circuitry 1304 may cause a “history” option 504, a “watch” option 508, an “overview” option 510, a “cast” option 516, and a “photos” option 518 to be presented and/or available to the user for selection.

In some embodiments, as shown in FIG. 5, control circuitry 1304 may shorten the length of sub-menu 502 compared to sub-menu 402, to contain only those options for which content is available.

In some embodiments, rather than omitting sub-menu options, control circuitry may gray-out sub-menu options for which no guidance data and/or content is available.

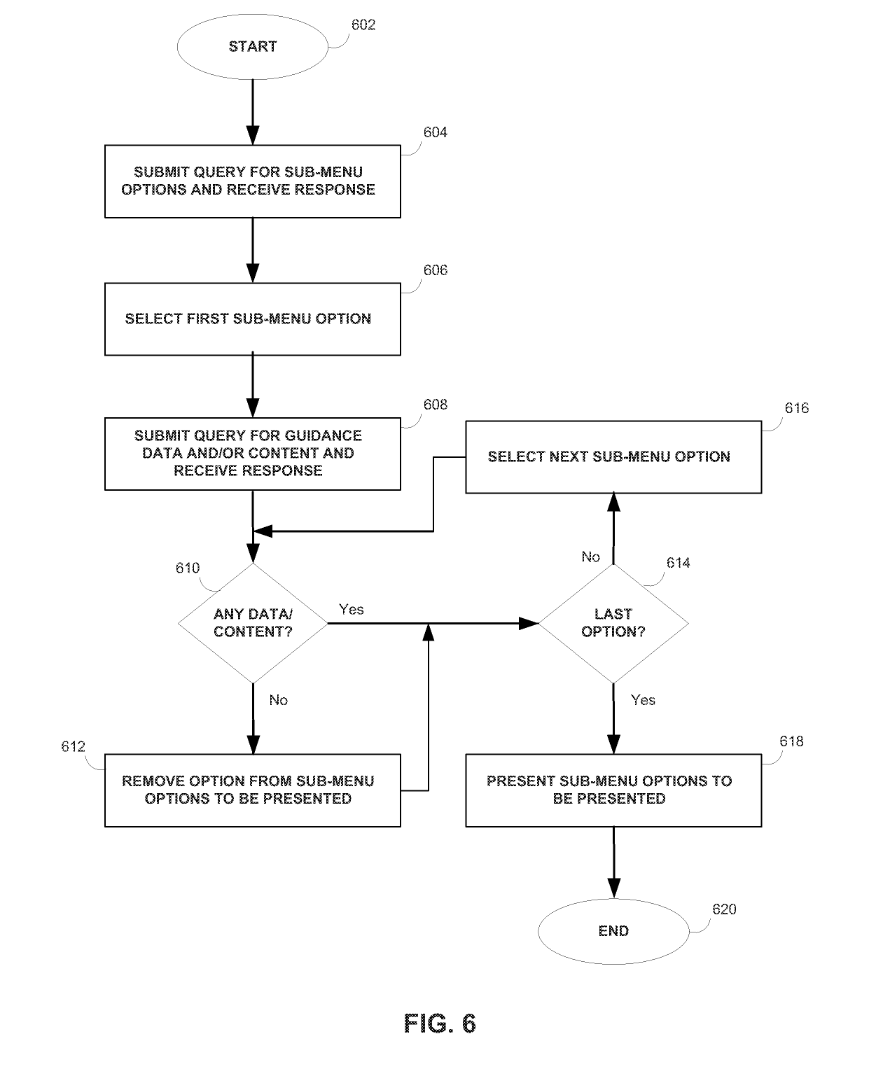

Any suitable process for determining whether guidance data and/or content is available for a primary option and sub-menu option combination can be used by control circuitry 1304 in some embodiments. For example, in accordance with some embodiments, control circuitry 1304 can implement a process such as process 600 of FIG. 6 in some embodiments. This process can be implemented at any suitable time before or during the presentation of the sub-menu options in some embodiments.

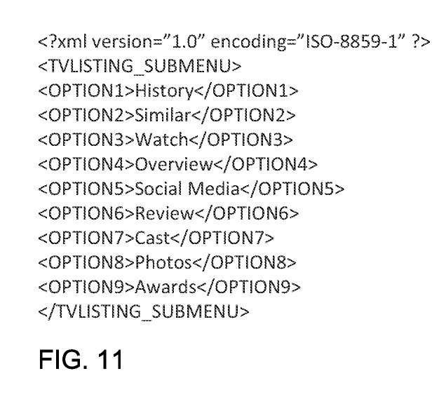

As shown, after process 600 begins at 602, control circuitry 1304 can submit a query to a database for sub-menu options for a given primary option (e.g., a primary option that has already been selected or a primary option that may be selected) (or a primary option type) and receive a response thereto at 604. Any suitable query and any suitable response can be used in some embodiments, and the query can be submitted to and the response received from any suitable database, memory, storage, etc. For example, in some embodiments, a response to a query for sub-menu options for a television program program listing type can be provided as an XML structure as illustrated in FIG. 11.

Next, at 606, control circuitry 1304 can select a first sub-menu option. The first sub-menu option can be any sub-menu option. Then, at 608, control circuitry 1304 can submit a query to a database for guidance data and/or content corresponding to the given primary option and the sub-menu option, and receive a response thereto. Any suitable query and any suitable response can be used in some embodiments, and the query can be submitted to and the response received from any suitable database, memory, storage, etc.

Control circuitry 1304 can then determine, at 610 whether any guidance data and/or content corresponds to the given primary option and the sub-menu option. Any suitable mechanism for making this determination can be used. For example, in some embodiments, control circuitry can determine that no guidance data and/or content is available upon receiving a message indicating no guidance data and/or content matches the query as described above.

When control circuitry 1304 determines at 610 that no guidance data and/or content is associated with the primary option and sub-menu option, then control circuitry 1304 may remove the sub-menu option from the sub-menu options to be presented and/or available at 612.

After removing the sub-menu option from the options to be presented and/or available at 612, or determining that guidance data and/or content is associated with the primary option and the sub-menu option, control circuitry 1304 can then determine at 614 if the current sub-menu option is the last of the sub-menu options for the primary option at 614. If control circuitry 1304 determines that the current sub-menu option is not the last of the sub-menu options, then control circuitry 1304 can select the next sub-menu option at 616 and loop back to 608. Otherwise, control circuitry 1304 can present the sub-menu options not removed at 612 (or designate them as to be presented if process 600 is performed in advance of the sub-menu options being displayed) at 618 and then terminate process 600 at 620.

It should be understood that some of the above steps of the flow diagram of FIG. 6 may be executed or performed in an order or sequence other than the order and sequence shown and described in the figure. Also, some of the above steps of the flow diagram of FIG. 6 may be executed or performed substantially simultaneously where appropriate or in parallel to reduce latency and processing times.

In some embodiments, control circuitry 1304 may determine whether or not there exists sub-menu options for a given or selected primary option by retrieving a data structure associated with the primary menu options. The data structure fields may be analyzed and parsed to determine which fields have corresponding content and which fields do not. Control circuitry 1304 may generate a display that includes sub-menu options corresponding only to those fields for which there exists content. For example, the primary menu option may be a program listing for a given program. In response to receiving a user selection of the program listing, control circuitry 1304 may retrieve a data structure from memory of the program corresponding to the selected listing. The data structure may include multiple fields (e.g., detailed description, preview clip, social media, website, purchase, download, transfer, and/or any other content fields). Control circuitry 1304 may parse through the fields of the data structure to identify which fields have corresponding content and which do not. For example, the data structure may include content for the detailed description field but may not have any social media content available for the social media field. Control circuitry 1304 may generate a display that includes only sub-menu options for the fields that have corresponding content. Control circuitry 1304 may exclude from the generate display sub-menu options for fields of the data structure for which no content is available.

In some embodiments, whether to present or make available menu options for which there is no corresponding guidance data and/or content can be based on user preferences, and, in some embodiments, can be determined on a menu option by menu option basis.

Although the preventing of the presentation or availability of a sub-menu option for which there is no corresponding guidance data and/or content is described above in connection with a program listing primary option in accordance with some embodiments, a primary option can additionally or alternatively be other than a program listing in some embodiments.

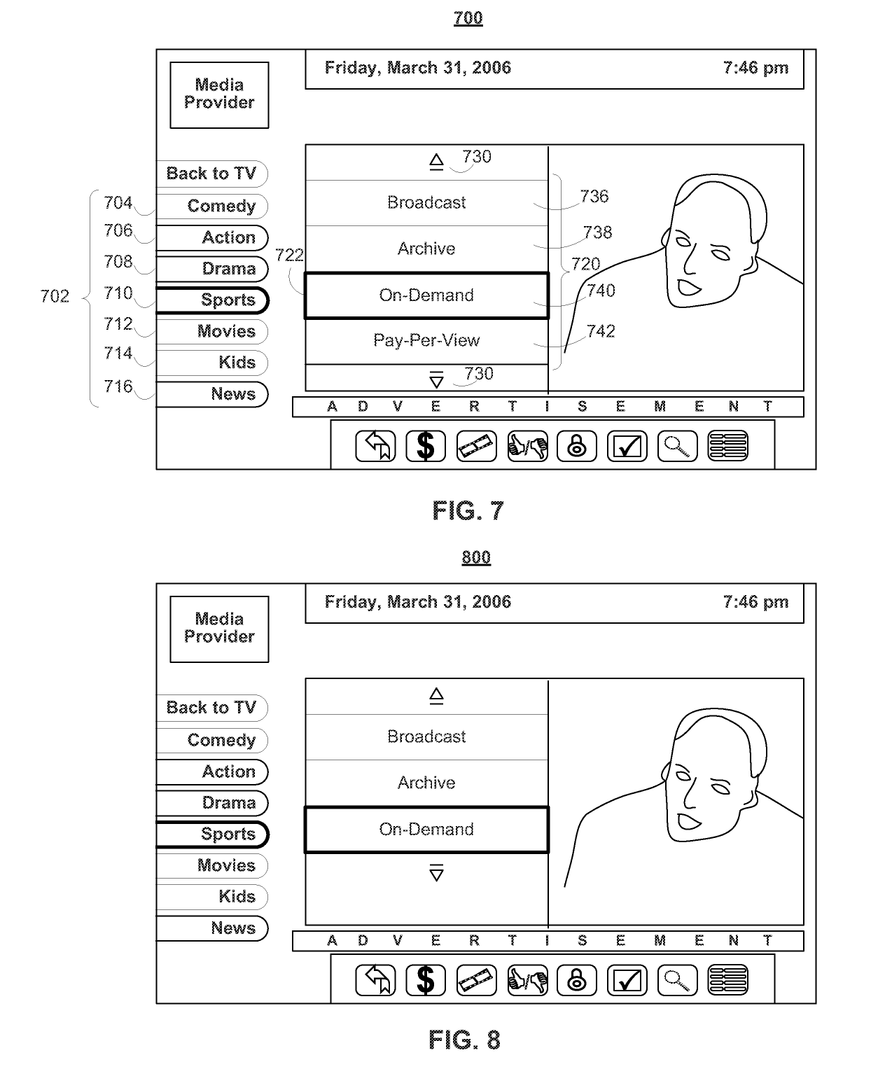

For example, as illustrated in FIG. 7, control circuitry 1304 can present a menu 702 of primary options, at least some of which are not program listings. Any suitable type of primary menu options can be presented in some embodiments. For example, as shown, in some embodiments, these primary menu options can include categories of program listings that can subsequently be displayed. Any suitable categories of program listings can be presented. For example, as shown, in some embodiments, these primary menu options can be a “comedy” option 704, an “action” option 706, a “drama” option 708, a “sports” option 710, a “movies” option 712, a “kids” option 714, and a “news” option 716 as shown in FIG. 7.

One of the primary menu options may be selected by a user using user input interface 1310. For example, as shown, a sports primary option 710 can be selected and this selection sent to control circuitry 1304. In response to receiving this selection, control circuitry 1304 may cause sub-menu options 720 to be presented. Any suitable sub-menu options can be presented in some embodiments.

As shown in display 700, sub-menu options to be presented can include a “broadcast” sub-menu option 736, an “archive” sub-menu option 738, an “on-demand” sub-menu option 740, and a “pay-per-view” sub-menu option 742. Control circuitry 1304 may enable a user to use user input interface 1310 to select one of sub-menu options 720 by moving highlight region 722 to the sub-menu option of the user's choice. Additional sub-menu options, if available, may be presented by control circuitry 1304 in response it receiving a user selection of one of the navigational icons 730.

Any suitable action may happen upon a user selecting a sub-menu option. For example, in response to a user selecting broadcast sub-menu option, control circuitry 1304 may present a grid of program guide information (e.g., as illustrated in FIG. 1) for sports currently being broadcast.

As described above, there may be scenarios in which there is no guidance data and/or content that corresponds to one or more of sub-menu options 720.

For example, a pay-per-view sub-menu option (as shown as option 742 in FIG. 7) may not have any available guidance data and/or content in the sports primary menu option and therefore control circuitry 1304 may prevent this sub-menu option from being presented or available as shown in display 800 of FIG. 8. Any suitable mechanism for preventing a sub-menu option from being presented or available can be used in some embodiments. For example, a process such as process 600 of FIG. 6 can be implemented in control circuitry 1304 to prevent a sub-menu option from being presented in a display such as display 800 of FIG. 8 in some embodiments. Similarly, in some embodiments, this sub-menu option can alternatively be grayed-out instead of being omitted.

In some embodiments, preventing the presentation or availability of sub-menu options as described above can be performed for given sub-menu options of a primary option where the primary option is a sub-menu option of another primary option. These given sub-menu options can be referred to herein as sub-sub-menu options.

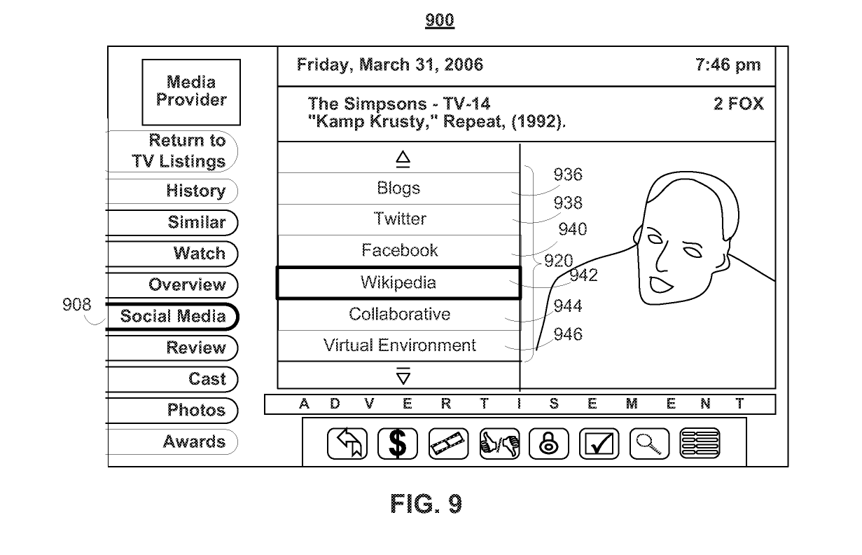

For example, as illustrated in FIG. 9, in response to control circuitry 1304 receiving a user selection of program listing 108 (FIG. 1), control circuitry 1304 may present a sub-menu including sub-menu option 908. In response to control circuitry 1304 receiving a selection of sub-menu option 908, the control circuitry may then present sub-sub-menu options 920. Any suitable sub-menu options may have sub-sub-menu options, and any suitable sub-sub-menu options can be used for each sub-menu option, in some embodiments.

For example, as shown in FIG. 9, sub-menu option 908 is entitled “Social Media.” Accordingly, corresponding sub-sub-menu options 920 may include a “blogs” sub-sub-menu option 936, a micro-blogging (“TWITTER”) sub-sub-menu option 938, a social networking (“FACEBOOK”) sub-sub-menu option 940, a content community (“WIKIPEDIA”) sub-sub-menu option 942, a “collaborative project” sub-sub-menu option 944, and a “virtual environment” sub-sub-menu option 946. TWITTER is a trademark owned by Twitter, Inc., FACEBOOK is a trademark owned by Facebook, Inc., and WIKIPEDIA is a trademark owned by Wikimedia Foundation, Inc.

In response to a user selecting blogs sub-sub-menu option 936, control circuitry 1304 may present guidance data on or content from one or more program correlated blogs, blogs of actors and crew members associated with the program, and/or any other blog related to the program. For example, in response to receiving a selection blogs sub-sub-menu option 936, control circuitry 1304 may present a list of one or more links to blogs authored by voice actors from a television series (e.g., THE SIMPSONS).

In response to a user selecting micro-blogging sub-sub-menu option 938, control circuitry 1304 may present guidance data on or content from one or more program correlated micro-blogging sites, micro-blogging sites of actors and crew associated with the program, and/or any other related micro-blogging sites. Examples of micro-blogging sites include, but are not limited to, TWITTER, TUMBLR, and POSTEROUS. For example, in response to receiving a selection of micro-blogging option 938, control circuitry 1304 may present a list of one or more links to TWITTER feeds authored by voice actors from a television series (e.g., THE SIMPSONS). TUMBLR is a copyright owned by Tumblr, Inc. and POSTEROUS is a trademark owned by Posterous, Inc.

In response to a user selecting social networking sub-sub-menu option 940, control circuitry 1304 may present guidance data on or content from one or more program correlated social networking sites, social networking sites of actors and crew associated with the program, and/or any other social networking sites related to the program. Examples of social networking sites include, but are not limited to, FACEBOOK, LINKEDIN, and MYSPACE. For example, in response to receiving a selection of social networking option 940, control circuitry 1304 may present a list of one or more FACEBOOK page links for THE SIMPSONS, which are dedicated to the television series. LINKEDIN is a copyright owned by LinkedIn Corporation and MYSPACE is a copyright owned by Myspace LLC.

In response to a user selecting content community option 942, control circuitry 1304 may present guidance data on or content from one or more sites or portions of sites related to the program in which the content has been generated by a community. Examples of these types of sites include, but are not limited to, WIKIPEDIA, REDDIT, and DIGGS. For example, in response to receiving a selection of content community option 942, control circuitry 1304 may present a WIKIPEDIA link that takes the user to a Web page which has content authored by multiple online members and gives information about THE SIMPSONS cartoon series. REDDIT is a copyright and trademark owned by Reddit Inc. and DIGGS is a copyright and trademark owned by Diggs Inc.

In response to a user selecting collaborative project option 944, control circuitry 1304 may present guidance data on or content from one or more online sites, in which other users are collaborating on projects relevant to the program. For example, in response to receiving a selection of a collaborative project option 944, control circuitry 1304 may present a list of one or more links to one or more online collaborative project sites where users can work in partnership with other users to create products related to THE SIMPSONS.

In response to a user selecting virtual environment option 946, control circuitry 1304 may present guidance data on or content from one or more options for participating online in one or more virtual environments and/or one or more sources of content for a virtual environment that is relevant to the program. For example, in response to receiving a selection of a virtual environment option 946, control circuitry 1304 may present a list of one or more links to one or more online virtual environments related to THE SIMPSONS.

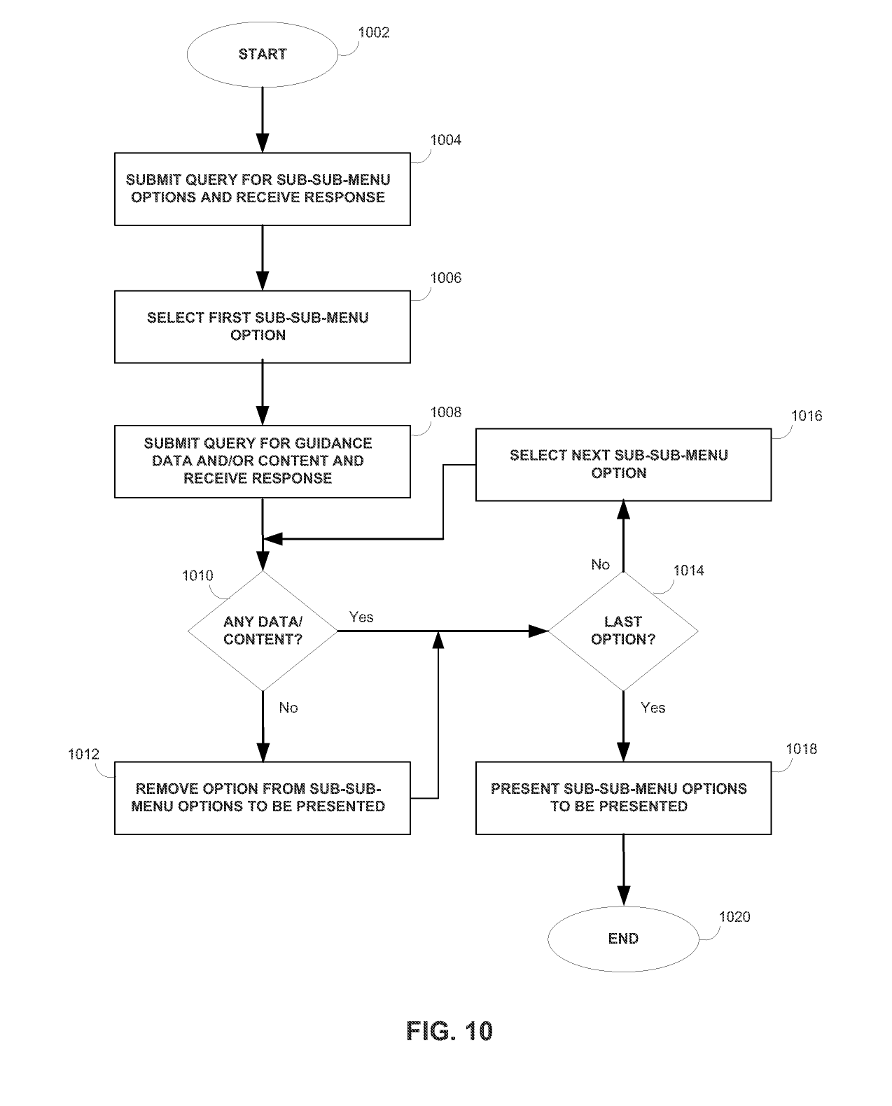

As described above, there may be scenarios in which there is no guidance data and/or content that corresponds to one or more of sub-sub-menu options 920. For example, a collaborative sub-sub-menu option (as shown as option 944 in FIG. 9) may not have any available guidance data and/or content and therefore control circuitry 1304 may prevent this sub-sub-menu option from being presented and/or available. Any suitable mechanism for preventing a sub-sub-menu option from being presented and/or available can be used in some embodiments. For example, a process such as process 1000 of FIG. 10 can be implemented in control circuitry 1304 to prevent a sub-sub-menu option from being presented and/or available in a display.

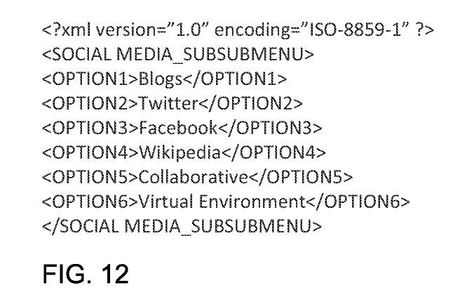

More particularly, for example, as shown in FIG. 10, after process 1000 begins at 1002, control circuitry 1304 can submit a query to a database for sub-sub-menu options for a given primary option (e.g., a primary option that has already been selected or a primary option that may be selected) (or a primary option type) and a sub-menu option (e.g., a sub-menu option that has already been selected or a sub-menu option that may be selected) (or a sub-menu option type) and receive a response thereto at 1004. Any suitable query and any suitable response can be used in some embodiments, and the query can be submitted to and the response received from any suitable database, memory, storage, etc. For example, in some embodiments, a response to a query for sub-sub-menu options for a television program listing type and a social media sub-menu option can be provided as an XML structure as illustrated in FIG. 12.

Next, at 1006, control circuitry 1304 can select a first sub-sub-menu option at 1006. The first sub-sub-menu option can be any sub-sub-menu option. Then, at 1008, control circuitry 1304 can submit a query to a database for guidance data and/or content corresponding to the given primary option, the sub-menu option, and the sub-sub-menu option, and receive a response thereto. Any suitable query and any suitable response can be used in some embodiments, and the query can be submitted to and the response received from any suitable database, memory, storage, etc.

Control circuitry 1304 can then determine, at 1010 whether any guidance data and/or content corresponds to the given primary option, the sub-menu option, and the sub-sub-menu option. Any suitable mechanism for making this determination can be used. For example, in some embodiments, control circuitry can determine that no guidance data and/or content is available upon receiving a message indicating no guidance data and/or content matches the query as described above.

When control circuitry 1304 determines at 1010 that no guidance data and/or content is associated with the primary option, the sub-menu option, and the sub-sub-menu option, then control circuitry 1304 may remove the sub-sub-menu option from the sub-sub-menu options to be presented and/or available at 1012.

After removing the sub-sub-menu option from the options to be presented and/or available at 1012, or determining that guidance data and/or content is associated with the primary option, the sub-menu option, and the sub-sub-menu option, control circuitry 1304 can then determine at 1014 if the current sub-sub-menu option is the last of the sub-sub-menu options for the primary option and sub-menu option at 1014. If control circuitry 1304 determines that the current sub-sub-menu option is not the last of the sub-sub-menu options, then control circuitry 1304 can select the next sub-sub-menu option at 1016 and loop back to 1008. Otherwise, control circuitry 1304 can present the sub-sub-menu options not removed at 1012 (or designate them as to be presented if process 1000 is performed in advance of the sub-sub-menu options being displayed) at 1018 and then terminate process 1000 at 1020.

It should be understood that some of the above steps of the flow diagram of FIG. 10 may be executed or performed in an order or sequence other than the order and sequence shown and described in the figure. Also, some of the above steps of the flow diagram of FIG. 10 may be executed or performed substantially simultaneously where appropriate or in parallel to reduce latency and processing times.

Although the preventing of the presentation and/or availability of menu options has been described herein in connection with sub-menu options and sub-sub-menu options, this technique can be performed with any suitable options, such as primary menu options, sub-sub-sub-menu options, sub-sub-sub-sub-menu options, and/or options at any layer in a menu structure.

Users may access content and the media guidance application (and its display screens described above and below) from one or more of their user equipment devices. FIG. 13 shows a generalized embodiment of illustrative user equipment device 1300. More specific implementations of user equipment devices are discussed below in connection with FIG. 14. User equipment device 1300 may receive content and data via input/output (hereinafter “I/O”) path 1302. I/O path 1302 may provide content (e.g., broadcast programming, on-demand programming, Internet content, content available over a local area network (LAN) or wide area network (WAN), and/or other content) and data to control circuitry 1304, which includes processing circuitry 1306 and storage 1308. Control circuitry 1304 may be used to send and receive commands, requests, and other suitable data using I/O path 1302. I/O path 1302 may connect control circuitry 1304 (and specifically processing circuitry 1306) to one or more communications paths (described below). I/O functions may be provided by one or more of these communications paths, but are shown as a single path in FIG. 13 to avoid overcomplicating the drawing.

Control circuitry 1304 may be based on any suitable processing circuitry such as processing circuitry 1306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1304 executes instructions for a media guidance application stored in memory (i.e., storage 1308).

In client-server based embodiments, control circuitry 1304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 14). In addition, communications circuitry may include circuitry that enables peer-to-peer communication of user equipment devices, or communication of user equipment devices in locations remote from each other (described in more detail below).

Memory may be an electronic storage device provided as storage 1308 that is part of control circuitry 1304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1308 may be used to store various types of content described herein as well as media guidance information, described above, and guidance application data, described above. Nonvolatile memory may also be used (e.g., to launch a boot-up routine and other instructions). Cloud-based storage, described in relation to FIG. 14, may be used to supplement storage 1308 or instead of storage 1308.

Control circuitry 1304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1304 may also include scaler circuitry for upconverting and downconverting content into the preferred output format of the user equipment 1300. Circuitry 1304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1308 is provided as a separate device from user equipment 1300, the tuning and encoding circuitry (including multiple tuners) may be associated with storage 1308.

A user may send instructions to control circuitry 1304 using user input interface 1310. User input interface 1310 may be any suitable user interface, such as a remote control, mouse, trackball, keypad, keyboard, touch screen, touchpad, stylus input, joystick, voice recognition interface, or other user input interfaces. Display 1312 may be provided as a stand-alone device or integrated with other elements of user equipment device 1300. Display 1312 may be one or more of a monitor, a television, a liquid crystal display (LCD) for a mobile device, or any other suitable equipment for displaying visual images. In some embodiments, display 1312 may be HDTV-capable. In some embodiments, display 1312 may be a 3D display, and the interactive media guidance application and any suitable content may be displayed in 3D. A video card or graphics card may generate the output to the display 1312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 1304. The video card may be integrated with the control circuitry 1304. Speakers 1314 may be provided as integrated with other elements of user equipment device 1300 or may be stand-alone units. The audio component of videos and other content displayed on display 1312 may be played through speakers 1314. In some embodiments, the audio may be distributed to a receiver (not shown), which processes and outputs the audio via speakers 1314.

The guidance application may be implemented using any suitable architecture. For example, it may be a stand-alone application wholly implemented on user equipment device 1300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 1300 is retrieved on-demand by issuing requests to a server remote to the user equipment device 1300. In one example of a client-server based guidance application, control circuitry 1304 runs a web browser that interprets web pages provided by a remote server.

In some embodiments, the media guidance application is downloaded and interpreted or otherwise run by an interpreter or virtual machine (run by control circuitry 1304). In some embodiments, the guidance application may be encoded in the ETV Binary Interchange Format (EBIF), received by control circuitry 1304 as part of a suitable feed, and interpreted by a user agent running on control circuitry 1304. For example, the guidance application may be an EBIF application. In some embodiments, the guidance application may be defined by a series of JAVA-based files that are received and run by a local virtual machine or other suitable middleware executed by control circuitry 1304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 1300 of FIG. 13 can be implemented in system 1400 of FIG. 14 as user television equipment 1402, user computer equipment 1404, wireless user communications device 1406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 14 may not be classified solely as user television equipment 1402, user computer equipment 1404, or a wireless user communications device 1406. For example, user television equipment 1402 may, like some user computer equipment 1404, be Internet-enabled allowing for access to Internet content, while user computer equipment 1404 may, like some television equipment 1402, include a tuner allowing for access to television programming. The media guidance application may have the same layout on various different types of user equipment or may be tailored to the display capabilities of the user equipment. For example, on user computer equipment 1404, the guidance application may be provided as a web site accessed by a web browser. In another example, the guidance application may be scaled down for wireless user communications devices 1406.

In system 1400, there is typically more than one of each type of user equipment device but only one of each is shown in FIG. 14 to avoid overcomplicating the drawing. In addition, each user may utilize more than one type of user equipment device and also more than one of each type of user equipment device.

In some embodiments, a user equipment device (e.g., user television equipment 1402, user computer equipment 1404, wireless user communications device 1406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 1414. Namely, user television equipment 1402, user computer equipment 1404, and wireless user communications device 1406 are coupled to communications network 1414 via communications paths 1408, 1410, and 1412, respectively. Communications network 1414 may be one or more networks including the Internet, a mobile phone network, mobile voice or data network (e.g., a 4G or LTE network), cable network, public switched telephone network, or other types of communications network or combinations of communications networks. Paths 1408, 1410, and 1412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 1412 is drawn with dotted lines to indicate that in the exemplary embodiment shown in FIG. 14 it is a wireless path and paths 1408 and 1410 are drawn as solid lines to indicate they are wired paths (although these paths may be wireless paths, if desired). Communications with the user equipment devices may be provided by one or more of these communications paths, but are shown as a single path in FIG. 14 to avoid overcomplicating the drawing.

Although communications paths are not drawn between user equipment devices, these devices may communicate directly with each other via communication paths, such as those described above in connection with paths 1408, 1410, and 1412, as well other short-range point-to-point communication paths, such as USB cables, IEEE 1494 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 1414.

System 1400 includes content source 1416 and media guidance data source 1418 coupled to communications network 1414 via communication paths 1420 and 1422, respectively. Paths 1420 and 1422 may include any of the communication paths described above in connection with paths 1408, 1410, and 1412. Communications with the content source 1416 and media guidance data source 1418 may be exchanged over one or more communications paths, but are shown as a single path in FIG. 14 to avoid overcomplicating the drawing. In addition, there may be more than one of each of content source 1416 and media guidance data source 1418, but only one of each is shown in FIG. 14 to avoid overcomplicating the drawing. (The different types of each of these sources are discussed below.) If desired, content source 1416 and media guidance data source 1418 may be integrated as one source device. Although communications between sources 1416 and 1418 with user equipment devices 1402, 1404, and 1406 are shown as through communications network 1414, in some embodiments, sources 1416 and 1418 may communicate directly with user equipment devices 1402, 1404, and 1406 via communication paths (not shown) such as those described above in connection with paths 1408, 1410, and 1412.

Content source 1416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 1416 may be the originator of content (e.g., a television broadcaster, a Webcast provider, etc.) or may not be the originator of content (e.g., an on-demand content provider, an Internet provider of content of broadcast programs for downloading, etc.). Content source 1416 may include cable sources, satellite providers, on-demand providers, Internet providers, over-the-top content providers, or other providers of content. Content source 1416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 1418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 1418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 1418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 1418 may provide user equipment devices 1402, 1404, and 1406 the media guidance application itself or software updates for the media guidance application.

Media guidance applications may be, for example, stand-alone applications implemented on user equipment devices. For example, the media guidance application may be implemented as software or a set of executable instructions which may be stored in storage 1308, and executed by control circuitry 1304 of a user equipment device 1300. In some embodiments, media guidance applications may be client-server applications where only a client application resides on the user equipment device, and server application resides on a remote server. For example, media guidance applications may be implemented partially as a client application on control circuitry 1304 of user equipment device 1300 and partially on a remote server as a server application (e.g., media guidance data source 1418) running on control circuitry of the remote server. When executed by control circuitry of the remote server (such as media guidance data source 1418), the media guidance application may instruct the control circuitry to generate the guidance application displays and transmit the generated displays to the user equipment devices. The server application may instruct the control circuitry of the media guidance data source 1418 to transmit data for storage on the user equipment. The client application may instruct control circuitry of the receiving user equipment to generate the guidance application displays.

Content and/or media guidance data delivered to user equipment devices 1402, 1404, and 1406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 1400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 14.

In one approach, user equipment devices may communicate with each other within a home network. User equipment devices can communicate with each other directly via short-range point-to-point communication schemes describe above, via indirect paths through a hub or other similar device provided on a home network, or via communications network 1414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 1416 to access content. Specifically, within a home, users of user television equipment 1402 and user computer equipment 1404 may access the media guidance application to navigate among and locate desirable content. Users may also access the media guidance application outside of the home using wireless user communications devices 1406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 1414. These cloud resources may include one or more content sources 1416 and one or more media guidance data sources 1418. In addition or in the alternative, the remote computing sites may include other user equipment devices, such as user television equipment 1402, user computer equipment 1404, and wireless user communications device 1406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 1404 or wireless user communications device 1406 having content capture feature. Alternatively, the user can first transfer the content to a user equipment device, such as user computer equipment 1404. The user equipment device storing the content uploads the content to the cloud using a data transmission service on communications network 1414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 13.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, BLU-RAY discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The above described embodiments of the present disclosure are presented for purposes of illustration and not of limitation, and the present disclosure is limited only by the claims which follow.

1. A method for presenting menu options in a media guidance application comprising:
receiving a user selection of a primary menu option in the media guidance application;
determining a plurality of sub-menu options that correspond to the primary menu option selected;
determining for each of the plurality of sub-menu options whether the sub-menu option has guidance data and/or content associated with the primary menu option selected; and
for each of the plurality of sub-menu options that does not have guidance data and/or content associated with the primary menu option selected, preventing the sub-menu option from being presented to a user.

2. The method of claim 1, wherein the guidance data and/or content is data.

3. The method of claim 1, wherein the guidance data and/or content is media.

4. The method of claim 1, wherein the primary menu option selected is a program listing option.

5. The method of claim 4, wherein a sub-menu option prevented from being presented to the user is one of: a history option; a similar option; a watch option; an overview option; a summary option; a review option; a cast option; a photos option; and an awards option.

6. The method of claim 1, wherein the primary menu option selected is a category of program listings.

7. The method of claim 6, wherein the category of program listings is one of comedy, action, drama, sports, movies, kids, and news.

8. The method of claim 7, wherein a sub-menu option prevented from being presented to the user is one of an on-demand listings option; a broadcast listings option; a pay-per-view listings option; and an archive listings option.

9. The method of claim 1, wherein the primary menu option selected is a social media option.

10. The method of claim 9, wherein a sub-menu option prevented from being presented to the user is one of: a blogging option; a micro-blogging option; a social networking option; a content community option; a collaborative project option; and a virtual environment option.

11. A system for presenting menu options in a media guidance application, the system comprising:
a storage device; and
processing circuitry configured to:
receive a user selection of a primary menu option in the media guidance application;
determine a plurality of sub-menu options that correspond the primary menu option selected;
determine for each of the plurality of sub-menu options whether the sub-menu option has guidance data and/or content associated with the primary menu option selected; and
for each of the plurality of sub-menu options that does not have guidance data and/or content associated with the primary menu option selected, prevent the sub-menu option from being presented to a user.

12. The system of claim 11, wherein the guidance data and/or content is data.

13. The system of claim 11, wherein the guidance data and/or content is media.

14. The system of claim 11, wherein the primary menu option selected is a program listing option.

15. The system of claim 14, wherein a sub-menu option prevented from being presented to the user is one of: a history option; a similar option; a watch option; an overview option; a summary option; a review option; a cast option; a photos option; and an awards option.

16. The system of claim 11, wherein the primary menu option selected is a category of program listings.

17. The system of claim 16, wherein the category of program listings is one of comedy, action, drama, sports, movies, kids, and news.

18. The system of claim 17, wherein a sub-menu option prevented from being presented to the user is one of: an on-demand listings option; a broadcast listings option; a pay-per-view listings option; and an archive listings option.

19. The system of claim 11, wherein the primary menu option selected is a social media option.

20. The system of claim 19, wherein a sub-menu option prevented from being presented to the user is one of: a blogging option; a micro-blogging option; a social networking option; a content community option; a collaborative project option; and a virtual environment option.

21-30. (canceled)
